(19) United States
(12) Patent Application Publication
(10) Pub. No.: US 2022/0120933 A1
(43) Pub. Date: Apr. 21, 2022

(54) METHOD OF DETECTION OF HYDROCARBON HORIZONTAL SLIPPAGE PASSAGES

(71) Applicant: Abu Dhabi National Oil Company, Abu Dhabi (AE)

(72) Inventors: Abdelwahab NOUFAL, Abu Dhabi (AE); Khalid OBAID, Abu Dhabi (AE)

(21) Appl. No.: 17/428,614

(22) PCT Filed: Feb. 5, 2019
(86) PCT No.: PCT/IB2019/050905

§ 371 Date: Aug. 4, 2021

(51) Int. Cl. G01V 11/00; G01V 99/00; E21B 49/00; E21B 47/002; E21B 49/02

(52) U.S. Cl. CPC G01V 11/002; G01V 99/005; E21B 49/003; E21B 2200/20; E21B 49/02; E21B 49/006; E21B 47/002

(57) ABSTRACT

The present invention relates to a method of detection of hydrocarbon horizontal slippage passages comprising the following steps: (a.) slippage passage data acquisition and identification; (b.) slippage passage prediction; (c.) slippage passage characterization; (d.) slippage passage calibration; and (e.) slippage passage parameterization and modelling. The present invention also relates to the use of such a method for positioning a well bore for hydrocarbon production.

### 1. TECHNICAL FIELD

The present invention relates to a method of detection of hydrocarbon horizontal slippage passages. Such detection can be used to improve oil and gas production by locating production perforations at locations of horizontal slippage passages.

### 2. BACKGROUND OF THE INVENTION

The present invention relates to a method of detection of hydrocarbon horizontal slippage passages. Such slippage passages are naturally occurring macroscopic planar discontinuities in rock due to deformation, and/or diagenesis. Thus, such slippage passages are generally horizontally oriented in a macroscopic view. Therefore, “horizontally” should not be understood in a strict mathematical sense. Each slippage passage marks a weak plane in the rock and possess different geometry, pattern, and fluid flow property. In hydrocarbon containing rock the slippage passages allow the flow of oil and gas. Therefore, in hydrocarbon production it is intended to localize slippage passages to be able to produce oil and gas from the slippage passages. The influence of hydrocarbon production by slippage passages is described in some scientific papers and patent documents, of the present inventors.

The paper Khalid Obaid, Abdelwahab Noufal, Mohamed Mahgoub; “Twisting Slip and Rotation of UAE Fault System”, 2017, teaches of Abu Dhabi fields which are influenced by strike-slip and their damage zones as a main tectonic regime. A damage zone is defined as the deformed volume of rocks around a fault surface that results from the initiation, propagation, interaction and build-up of slip along fault segments. The damage zones thus impact the distribution of the migration pathways which in turn increase the drilling risks. It was found that slippage and rotation along the fault segments in Abu Dhabi fields increase the damage zones widths around the fault segments. The paper goes further to describe that faults and shears act as migration pathways for oil and gas.

Although, the paper is related to the influence of strike-slip fault and the corresponding damage zones on Abu Dhabi fields, that are developed due to tectonic activities, it does not disclose a method to identify slippage passages.

The paper Yasmin Abu Hiljeh, Sabah Al-Hosani, Adbelwahab Noufal “Characteristics of Fault Zones in Layered Carbonate Sequences, Onshore Abu Dhabi, UAE”, 2016, discusses the mechanical and kinematic properties and the structural architecture of fault zones and their importance in structural geometry and fluid flows rates. The paper discusses that, the increase in permeability is associated with these stressed faults. The stressed faults result from brecciation during shearing and formation of a damage zone adjacent to the faults. The change in pore-pressure in any context can have influence on slippage potential of these deformation zones and can contribute changes to the reservoir permeability tensor. The zones are thus denoted and identified by enhanced fluid flow transmissibility. Further, that these zones can have greater permeability than the host rock. The method, however, does not disclose the detection of horizontal slippage passages.

Document U.S. Pat. No. 6,266,618 B1 teaches a specific method for automatic detection of planar heterogeneities crossing the stratification of an environment from images of borehole walls or developments of core samples of said environment. The method, however, does not disclose the detection of horizontal slippage passages.

Document U.S. Pat. No. 6,819,111 B2 teaches a method for determining horizontal and vertical resistivity in an anisotropic formation using a combination of orientable triaxial an array antenna conveyed downhole. The method, however, does not disclose the detection of horizontal slippage passages.

Thus, it is an object of the invention to provide a method for the reliable and fast detection of hydrocarbon horizontal slippage passages.

### 3. SUMMARY OF THE INVENTION

The above mentioned problem is solved by a method of detection of hydrocarbon horizontal slippage passages comprising the following steps:
a. slippage passage data acquisition and Identification (10);
b. slippage passage prediction (20);
c. slippage passage characterization (30)
d. slippage passage calibration (40).
e. slippage passage parameterization and modelling (70).

The method allows a fast and reliable preferably automatic or semi-automatic detection of hydrocarbon horizontal slippage passages and improves hydrocarbon production. In the step of slippage passage data acquisition all necessary data is acquired that is used for the detection of hydrocarbon horizontal slippage passages.

In the step of slippage passage prediction one or more review for individual wells is performed based on the acquired slippage passage data. The acquired slippage passage date, preferably BHI (Borehole Image) with picking of all structural data (fractures and bedding) is used to generate a model of the reservoir main porosity contribution coming from matrix or secondary porosity.

In the step of slippage passage characterization, the performed reviews for individual wells are combined to generate field wide slipping passage characterization data. This step generates a model of the porosity and permeability contributors, which shows these are the direct contribution of slippage passages. This step has the technical effect of delineating the flow contributors in the reservoir laterally.

In the step of slippage passage parameterization and modelling the field wide slipping passage characterization data is used to generate different preferably 3-dimensional models that describe the field in terms of slipping passage parameters like slipping passage porosity, slipping passage permeability and effective slipping passage permeability.

Preferably, the step of slippage passage data acquisition and identification comprises data acquisition in stratified rock. Thus, the input data of the detection method corresponds to the different layers of the rock of interest.

Preferably, the step of slippage passage data acquisition and identification comprises acquiring borehole image data. Thus, borehole image data is used as input data for the detection method. Such borehole image data is comparably easy to produce.

Preferably step of slippage passage data acquisition and identification comprises an acquisition of one or more of
a. density data,
b. gamma ray data;
c. sonic compressional data;
d. fast sonic shear data;
e. slow sonic shear data; and
f. core data.

Further input data to the detection method can be density data, gamma ray data, sonic compressional data, fast sonic shear data, slow sonic shear data and core data. Such data can be used for creating a 1-dimensional geomechanics model of a well.

Acoustic measurements using a full-waveform, wideband-frequency sonic tool can preferably be used to evaluate the stress regime and direction using both near field flexural-shear and Stoneley waves, as well as far field P-wave reflections. Zones showing differences in the 3-shear moduli permit a quantification of stress magnitudes as a function of the principal stresses in the near wellbore region. Whereas the far-field reflections of the P-wave in all azimuths are utilized to determine the dip and azimuth of interpreted slippage passages and/or fractures extending 10's of meters away from the wellbore using 3-dimensional Slowness-Time-Coherence and ray tracing. The stress field at the wellbore scale, and in the far-field should be consistent to accurately represent the in-situ stress state.

Preferably, the step of slippage data acquisition comprises one or more of the following steps:
a. core analysis;
b. bore hole image analysis;
c. drilling data analysis;
d. dynamic data analysis;
e. seismic attribute analysis; and
f. curvature/strain analysis.

The core analysis is preferably done by describing the core structurally, collecting all the features characterizing the slippage passage, in addition to diagenesis description and provides matching the BHI with the core; structural analysis and diagenetic features.

The bore hole image analysis is preferably done by a geologist, who possess structural geology background and provides structural analysis of the slippage passages, differentiation between primary (matrix) and secondary porosity (Slippage passages, voids and fractures)

The drilling data analysis is preferably done by a geomechanics engineer and provides an analysis of data of drilling events, like lost circulation events, stuck pipes, etc., which are collected while drilling.

The seismic attribute analysis is preferably done by seismic interpreter with advanced structural geology background and provides the best attributes describing the slippage passages.

Curvature/strain analysis is preferably done by a geomechanics engineer and provide strain maps and comparing these maps with the attributes showing slippage passages.

Preferably the step of slippage passage prediction comprises one or more of the following steps:
a. petrophysical review;
b. determining of slippage passage potential index (SPPI);
c. azimuth, edge, coherency determination and tracking; and
d. curvature/strain analysis.

The azimuth, edge, coherency determination and tracking are done by seismic interpreter with structural geology background and provides directions and main trends of the slippage passages.

A far-field fracture orientation indicates the direction of stress is determined with acoustic reflection data. Individual dip and azimuth information from these reflectors are made possible with a new 3-dimensional STC processing method, along with ray tracing to provide a confidence factor for each event. The integration with near-wellbore stress indicators (images, calipers) are done to provide a complete integrated workflow.

The curvature/strain analyses are done by a seismic interpreter with structural geology background and provide seismic main trends of the slippage passages and matching these with the BHI data and logs.

Preferably the step of slippage passage calibration comprises one or more of the following steps:
a. PLT (Production Logging Tool), production data build-up time & RFT (Repeat Formation Tester)/MDT (Modular Dynamic Formation Tester) review;
b. well test review;

The PLT, production data build-up time & RFT/MDT review is preferably done by a geomechanics engineer and provides calibration points for the 1-dimensional geomechanics model, and pressure matching.

The well test review is preferably done by a production engineer and provides the flow contribution horizons (intervals).

The petrophysical review is preferably done by a petrophysicist and provides facies descriptions.

The slippage passage potential index (SPPI) is a measure of connectivity along the high porosity zones. It is determined by connectivity of the BHI along the slippage passages.

Preferably, the step of slippage passage prediction comprises the step of creating a 1-dimensional geomechanics model. The 1-dimensional geomechanical model preferably represents one well in terms of slippage passage data. The 1-dimensional geomechanical model identifies the stress regime, elastic and mechanical parameters. It is found that the slippage passages are intensive in the zones of strike slip regime.

Preferably the step of slippage passage characterization comprises one or more of the following steps:
a. creating slippage passage density log and/or slippage passage spacing log for a plurality of wells;
b. slippage passage aperture analysis;
c. estimation of slippage passage density in between of the wells; and
d. geomechanics stress analysis and/or evaluation.

In the step of creating slippage passage density log and/or slippage passage spacing log for a plurality of wells preferably the BHI deliver a porosity image along the slippage passages with porosity determination only from the BHI. Then creating connectivity analysis is preferably performed to indicate the conductivity along the slippage passages and the connectedness, which will be an indication of the permeability. This will be done by a geologist with structural geology background.

In the step of slippage passage aperture analysis preferably the porosity distribution and the quantity of secondary porosity fraction can be obtained. The primary assumption for this technique is that the resistivity data from the electrical images is measured in the flushed zone of the borehole. The electrical images are then transformed into a porosity image of the borehole after calibration with external shallow resistivity and log porosity. The following equation is used to get such transformation as described in Akbar, Mahmoud; Chakravorty, Sandeep; Russell, S. Duffy; Al Deeb, Maged A.; Efnik, Mohamed R. Saleh; Thower, Roxy; Karakhanian , Hagop; Mohamed, Sayed Salman; Bushara, Mohamed N. in “Unconventional Approach to Resolving Primary and Secondary Porosity in Gulf Carbonates from Conventional Logs and Borehole Images”; Abu Dhabi International Petroleum Exhibition and Conference, year 2000; SPE-87297-MS,

ϕᵢ=ϕₑₓₜ(Rₑₓₜ*Cᵢ)^{l/m}

where ϕi is the derived porosity for each element of the image, ϕext and Rext are the porosity and the shallow resistivity respectively, from conventional logs, Ci is conductivity of each button from the image and m is Archie cementation exponent. An automated analysis of this porosity image, windowed over short intervals (generally 1.2 inch), provides a continuous output of primary and secondary porosity components of the rocks. At every specified sampling rate porosity distribution histograms are computed. The homogeneous reservoir intervals give narrow unimodal distribution. In slippage passages, of the heterogeneous reservoirs, bimodal distribution of porosity is observed. A continuous cutoff is applied to the porosity histograms to separate the contribution of secondary porosity from the matrix fraction. So, the porosity points above the threshold correspond to secondary porosity and those below correspond to the matrix. This will quantify the secondary porosity related to the slippage passages.

In the step of estimation of slippage passage density in between of the wells preferably a comparison of the BHI results and catching the slippage passages intervals showing high connectedness is performed, which provides the lateral extension with the reservoirs. This step preferably needs integration of the BHI geologist with the seismic interpreter. In addition, by creating the 1-dimensional geomechanics models and calculating the elastic parameters (Young's modulus and Poisson Ratio), the elastic parameters of the connected slippage passages intervals are taken into consideration.

In the step of geomechanics stress evaluation preferably on the 1-dimensional geomechanics model the zones of the slippage passages undergoing strike slip are differentiated from the zones of extensional regime. This will highlight the zonation, where the stresses are transferred laterally along the slippage passages. The 1-dimensional geomechanics model deliverables is the vertical stresses and the maximum and minimum horizontal stresses, which indicate the regime.

Preferably, the step of slippage passage parameterization and modelling comprises one or more of the following steps:
a. creating a slippage passage porosity distribution model;
b. creating a slippage passage permeability distribution model; and
c. creating an effective slippage passage permeability distribution model.

The step of creating a slippage passage porosity distribution model preferably uses the results of the step of slippage passage aperture analysis. Further, in this step preferably porosity from isolated pore space, connected pore space, pore space at/connected to slippage passages and porosity from matrix is calculated and evaluated. The BHI image is first transformed into porosity image in similar fashion to the conventional porosity method proposed by (Newberry, Grace, & Stief, 1996), then, the porosity image is associated with the classified heterogeneity image generated to classify the porosity values.

In the step of creating a slippage passage permeability distribution model preferably the calibrated image, dynamic image and the matrix image is used to delineate the heterogeneities.

In the step of creating an effective slippage passage permeability distribution model slippage passages segments are extracted. This step can be carried out separately or combined with manual picking of slippage passages from previous step to identify the heterogeneity associated with slippage passages and calculate the slippage-associated porosity, especially in cases where the slippage passages are not planar and can't be fully picked. The segment extraction method described in Kherroubi, Josselin, “Automatic extraction of natural fracture traces from borehole images”, in IEEE, 19th International Conference on Pattern Recognition, year 2008 is the preferred technique used to do this. The method, based on mathematical morphology theory, allows to automatically extract separately the low apparent-dip fracture segments and the high-apparent-dip segments. The method produces fast, efficient and repeatable results. Matrix Extraction: In this process, the background of the image, which corresponds to the geological term matrix, is computed by removing non-crossing features on images such as vugs, molds, fracture segments, and slippage passages. The main part of the processing is done by the gray-scale reconstruction transform, as described in Vincent, Luc, “Morphological grayscale reconstruction in image analysis: applications and efficient algorithms” in IEEE, IEEE Transactions on Image Processing, year 1993, 176-201, which removes the features not traversing the image. The matrix image is an essential input in the heterogeneity delineation process and in turn the slippage passages workflow.

Preferably, the steps of creating a slippage passage porosity distribution model; creating a slippage passage permeability distribution model; and creating an effective slippage passage permeability distribution model comprise an upscaling and a 3-dimensional facture intensity modelling.

Preferably, the steps of creating a slippage passage porosity distribution model; creating a slippage passage permeability distribution model; and creating an effective slippage passage permeability distribution model comprise the step of creating a DFN/IFM stochastic slippage passage network. This step preferably comprises identification of the potential flow contributing slippage passages differentiated from the fractures with detailed BHI analysis as described above. Further, this step preferably comprises a prediction of slippage passages intensity, like the fracture intensity between the wells within the reservoir using continuous fracture modeling (CFM) technique. Further, it preferably comprises generating the DFN/IFM (implicit fracture model) with calibration of the fracture/slippage distribution, geometry, trends and calibrating these with the BHI.

Preferably, the step of slippage passage parameterization and modelling comprises the step of creating a 3D MEM and strain map.

Once data is available in terms of many 1-dimensional geomechanics models, a 3-dimensional geomechanics model (or MEM, Mechanical Earth Model) is generated by distributing the geomechanics 3-dimensional model driven by seismic (creating seismic pre-stack inversion to get the elastic parameters), then calibrating these seismic generated elastic parameters with those from the wells (1-dimensional geomechanics models) is performed. This will deliver a 3-dimensional calibrated Geomechanics model, and integrating these with the slippage passages results from the previous steps based on BHI. The 3-dimensional geomechanics model allow forwarding the geomechanics modeling, which will create stress and strain maps. The slippage passages, are zones of high deformation relative to the above and below and therefore accompanying with high strain zonations. This allows to follow the slippage passages laterally away from the wells and allows an optimized well placement for targeting the high production intervals.

Further, the above mentioned problem are solved by using the method of detection of hydrocarbon horizontal slippage passages as described above for positioning a well bore for hydrocarbon production.

The slippage passages are located in areas that are dominated with higher Young's Modulus and maximum horizontal stresses. Therefore, the well location can be planned with different approaches:

Seismic:

This approach is applicable for the exploration phase when well datasets are limited. Horizons and faults can be interpreted from basic 2-dimensional/3-dimensional seismic interpretation in order to create the structural framework. If strike-slip faults are observed, they will apparently indicate the occurrence of transpressional/transtensional features between the fault segments i.e. higher horizontal stresses. Hence, directional wells should be drilled parallel to the strike-slip faults.

3-Dimensional Geomechanics Model:

In the appraisal phase, few wells with log and core data could be available. Then it is possible to conduct a 1-dimensional geomechanics model (MEM: Mechanical Earth Model), on single well then populate the rock properties and create a 3-dimensional geomechanics model using statistical algorithms which provide qualitative predictions of stresses and strains in the reservoir formation.

Advanced 3-Dimensional Seismic Driven Geomechanics Analysis:

In the development phase, pre-stack 3-dimensional seismic datasets and well data should be available. Then the basic 3-dimensional geomechanics model has to be calibrated with quantitative deliverables from pre-stack seismic inversion such as Vp/Vs, Poisson Ratio, and Young Modulus. With advanced azimuthal inversion, horizontal stresses can be estimated from seismic in order to guide directional drilling and completion (see for a general example that is not related to slippage passage detection, Peake, N., G. Castillo, N. Van de Coevering, S. Voisey, A. Bouziat, K. Chesser, G. Oliver, C. Vinh Ly, and R. Mayer, 2014, Integrating surface seismic, microseismic, rock properties and mineralogy in the Haynesville Shale: Unconventional Resources Technology Conference, 343-353).

### 4. SHORT DESCRIPTION OF THE DRAWINGS

In the following, preferred embodiments of the invention are disclosed by reference to the accompanying figures, in which shows:

FIGS. 1A and 1B a workflow for slippage passage detection and elements of a method of detection of hydrocarbon horizontal slippage passages according to a preferred embodiment;

FIG. 2 an exemplary 2-dimensional illustration of results of the method according the invention;

FIG. 3 shows a preferred process of generating a creating a slippage passage permeability distribution model;

FIG. 4 exemplary DFN with seismic attribute images for slippage passages; and

FIG. 5 an exemplary 3-dimensional geomechanics model, showing a slippage passages distribution.

### 5. DETAILED DESCRIPTION OF PREFERRED EMBODIMENTS

In the following, preferred embodiments of the invention are described in detail with respect to the figures.

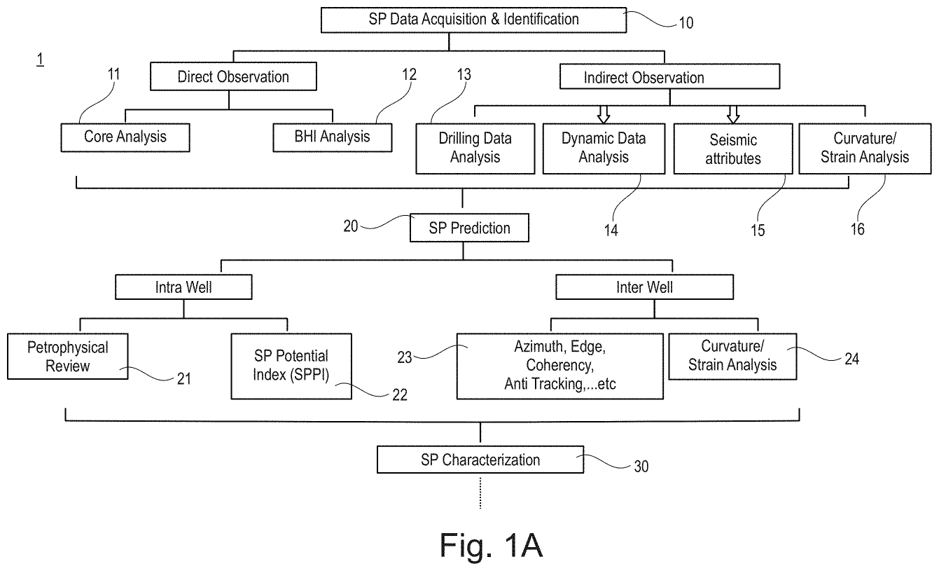

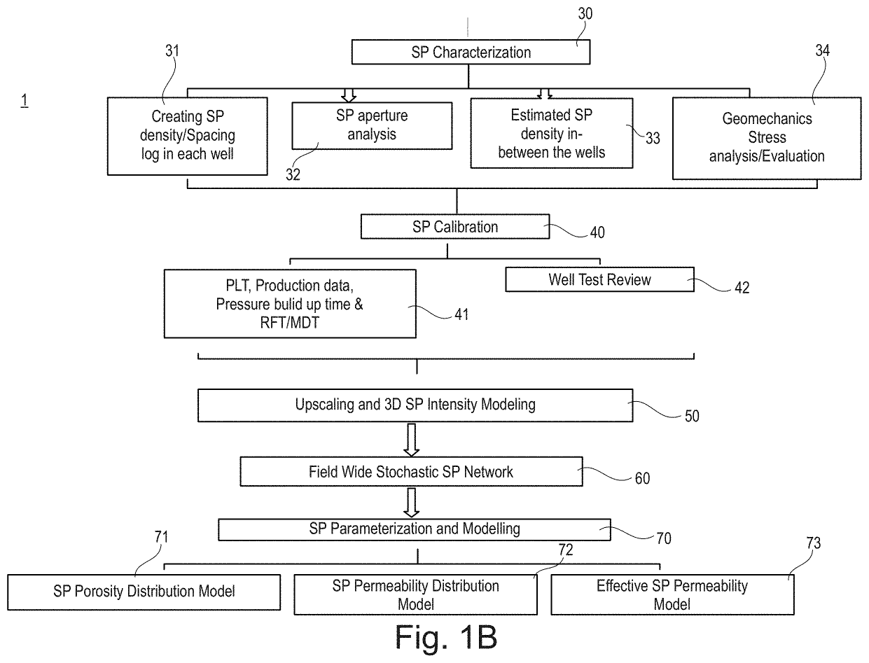

FIGS. 1A and 1B seen together show a workflow 1 for slippage passage detection and elements of a method of detection of hydrocarbon horizontal slippage passages according to a preferred embodiment. The workflow 1 comprises the main steps of slippage passage data acquisition and identification 10, slippage passage prediction 20, slippage passage characterization 30, and slippage passage parameterization and modelling 70

The step of slippage passage data acquisition 10 can be performed by direct observation of well data or indirect observation of data of the surrounding of the well. It preferably comprises one or more of the following steps:
a. core analysis 11;
b. bore hole image analysis 12;
c. drilling data analysis 13;
d. dynamic data analysis 14;
e. seismic attribute analysis 15; and
f. curvature/strain analysis 16.

The step of slippage passage prediction 20 can be performed intra well for one specific well or inter well, regarding the relationships of a plurality of wells. It preferably comprises one or more of the following steps:
a. petrophysical review 21;
d. determining of slippage passage potential index (SPPI) 22;
e. azimuth, edge, coherency determination and tracking 23; and
f. curvature/strain analyses 24.

The step of slippage passage characterization 3o preferably comprises one or more of the following steps:
a. creating slippage passage density log and/or slippage passage spacing log for a plurality of wells 31;
b. slippage passage aperture analysis 32;
c. estimation of slippage passage density in between of the wells 33; and
d. geomechanics stress analysis and/or evaluation 34.

The step of slippage passage calibration 40 preferably comprises one or more of the following steps:
a. PLT (Production Logging Tool), production data build-up time & RFT (Repeat Formation Tester)/MDT (Modular Dynamic Formation Tester) review 41; and
b. well test review 42.

The method of detection of hydrocarbon horizontal slippage 1 further comprises the step of slippage passage upscaling and 3-dimensional slippage passage intensity modeling 50.

The method of detection of hydrocarbon horizontal slippage 1 further comprises the step of generating a field wide stochastic slippage passage network 60.

The step of slippage passage parametrization and modelling 70 preferably comprises one or more of the following steps:
a. creating a slippage passage porosity distribution model 71;
b. creating a slippage passage permeability distribution model 72; and
c. creating an effective slippage passage permeability distribution model 73.

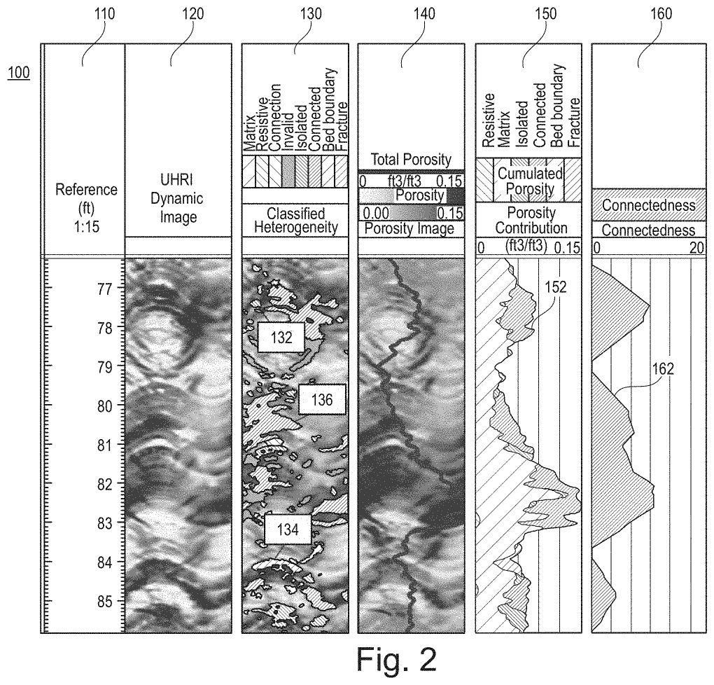

FIG. 2 shows an exemplary 2-dimensional illustration 100 of results of the method 1. In track no the reference depth of the formation under investigation is provided. Track 120 shows a UHRI dynamic image of the formation. Track 130 shows a classified heterogeneity image and track 140 a porosity image generated from calibrated UHRI image and total porosity log. Track 150 shows a porosity contribution per texture class using porosity image 140 and the classified heterogeneity image 130. Track 160 shows a connectedness curve generated for connected porosity. In the classified heterogeneity image 130 isolated porosity 132 and fracture connected porosity 134 is shown together with connected porosity 136.

The step of creating a slippage passage porosity distribution model 71 preferably uses the results of the step of slippage passage aperture analysis 32. For example, as shown in FIG. 2 a value in the porosity image 120 which is at a connected conductive spot in the heterogeneity image 130 is classified as porosity from connected conductive spot. Two types of curves are created for each heterogeneity class. The first curve 152 is the contribution of each texture category to the total image porosity, the second one 162 is the average porosity of each texture class. The textural and porosity analysis in reservoir revealed varying amount of heterogeneity in form of conductive and resistive (dense) areas across the whole interval. The conductive heterogeneities are due to porous areas (patches of intergranular and intercrystalline porosity, mouldic, vuggy porosity and slippage passages conductive intervals) of different size, shape and conductivity. The resistive heterogeneities are due to dense cemented areas of lower or zero porosity. The extracted quantitative information from BHI was used to identify several heterogeneous zones associated with higher secondary porosity and higher connectedness zones, most of the connected porosity zones were found in two units of the FIG. 2 showing one example. Track 150 shows the image extracted porosity type contributions to total porosity. The shading in track 150 indicates the contribution from each pore type. The quantitative information on the different pore types 152 and the pore connectedness index 162 is very useful for identifying the most productive zones in reservoir and to understand the correlations between various reservoir porosity components and well productivity data.

In this exemplary well of FIG. 2, a PLT survey was carried out to define the production profile. Good production contribution has been obtained from intervals where standard logs show low porosity whereas the slippage passages zones having higher porosity and responsible for the main production. Excellent correlation, however, is observed between production log profile and the connectedness log 160 derived from the borehole image 120. It is inferred that the variation in production profile is triggered by the slippage passage variation in the reservoir, i.e. zones dominated by connected slippage passages yield higher production rate whereas less rates are observed in zones dominated by other zones. Zones dominated by isolated vuggy porosity and matrix porosity have little to no contribution to production. The pore connectedness index 160 provides a significant and relevant qualitative measure to predict the producibility and can be used to optimize the completion in future wells.

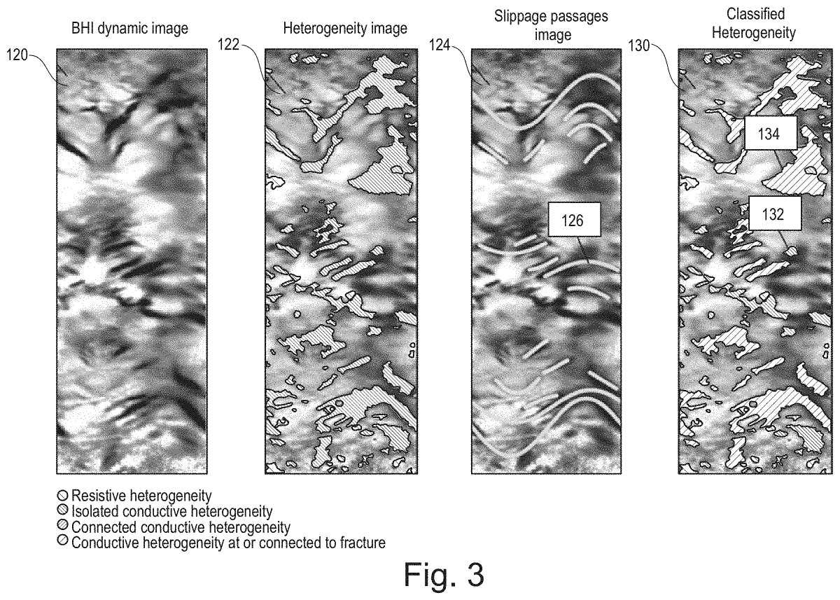

FIG. 3 shows the process of generating a creating a slippage passage permeability distribution model 72 by an example of conductive heterogeneity sub-classified into fracture connected heterogeneity. The first track shows the BHI dynamic image 120. The second track shows a conductive heterogeneity image 122. The third track shows a slippage passage image 124 with fracture sinusoids 126 that have been previously picked or extracted using segment extraction methods. The fourth track shows the subcategorized heterogeneity image 130 using fracture dips conductive heterogeneity at or connected to fractures 134 (orange) and into isolated conductive heterogeneity 132 (green).

In the step of creating a slippage passage permeability distribution model 72 preferably the calibrated image, dynamic image 120 and the matrix image is used to delineate the heterogeneities. The entire image is first segmented into mosaic pieces (segments) using a well-known image segmentation method called watershed transform method as explained in Meyer, F.; Beucher, S., “Morphological segmentation” in “Journal of Visual Communication and Image Representation”, year 1990, pages 21-46. Each mosaic piece is characterized by its attributes such as the peak/valley value, contrast against matrix image, size, and type. Two mosaic types are extracted: conductive type (the mosaic pieces above matrix image) and resistive type (the mosaic pieces below matrix image). To examine the connectedness between conductive mosaic pieces, crest lines are extracted by applying the watershed transform to the original image. The crest line of the image helps identify the isolated and connected conductive features. A cut-off value is applied then on the mosaic pieces attributes (value and contrast) to extract the conductive heterogeneities (e.g. slippage passages) and the resistive heterogeneities (e.g. cemented patches). The extracted conductive heterogeneity spots 122 are subclassified into different categories 132, 235, 136. Spots connected by crest lines to another spot are classified as connected spots 136. The spots connected to slippage passages (previously extracted slippage traces and dips) are classified as slippage passages spots 126, which are the spots aligned along slippage passages are classified, and the rest are classified as isolated conductive spots 132. Size, contrast, and surface proportion of each spot/heterogeneity category are computed and represented as curves. The connectedness (is compatible to permeability) curve 162 is extracted, and it is defined by the average of the differences in conductivity between matrix and crest line (zero if there is no line) at each depth level. This curve is a very good indicator for productive zones. It is also possible here to exclude the conductive spots related to clay layers, stylolites, induced fractures and borehole breakouts using the relevant dips previously picked, such spots are classified as false porosity and it will be excluded from the porosity calculations.

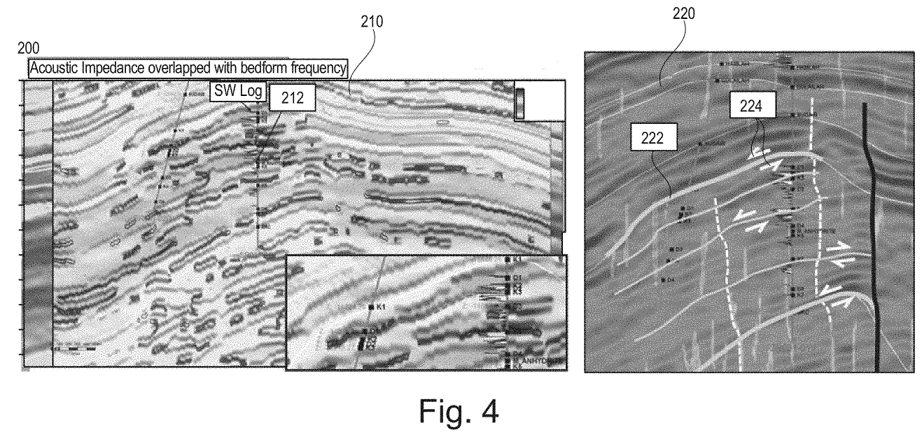

FIG. 4 shows a field wide stochastic slippage passage Network 60. The acoustic impedance overlapped with bedform frequency 200 comprises on the left side the seismic attribute image 210 for slippage passages and to the right a seismic image 220 with slippage passages 222 and arrows 224 indicating slippage directions along the horizons. Generally, a stochastic slippage network model 210 is created as a basic step as attribute, along with creating the slippage passages interpretation 220 and comparing both. Then comparing the results from the BHI with the flow directions 224 of the stochastic slippage passage network 200 and those attributes related to the slippages passages 222 attributes.

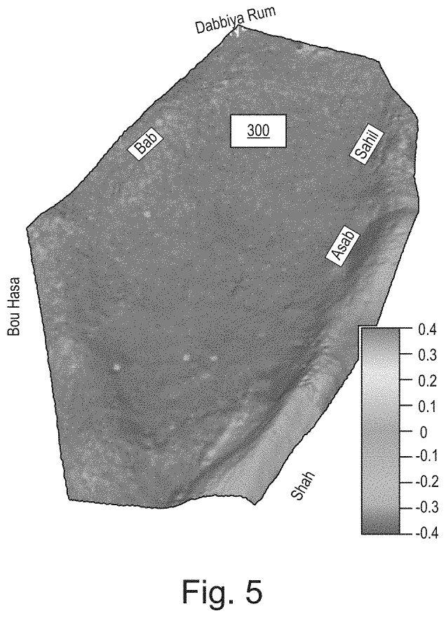

FIG. 5 shows an exemplary 3-dimensional geomechanics model (MEM) with a strain map 300 obtained by a step 50 of creating a 3-dimensional MEM and strain map 300. The upscaled and extrapolated locations of extreme values of shear stress indicate the presence of potential slippage passages.

1. Method of detection of hydrocarbon horizontal slippage passages comprising the following steps:
a. slippage passage data acquisition and identification;
b. slippage passage prediction;
c. slippage passage characterization;
d. slippage passage calibration; and
e. slippage passage parameterization and modelling.

2. Method of detection of hydrocarbon horizontal slippage passages according to claim 1, wherein the step of slippage passage data acquisition and identification comprises data acquisition in stratified rock.

3. Method of detection of hydrocarbon horizontal slippage passages according to claim 1, wherein the step of slippage passage data acquisition and identification comprises acquiring borehole image data.

4. Method of detection of hydrocarbon horizontal slippage passages according to claim 1, wherein the step of slippage passage data acquisition and identification comprises an acquisition of one or more of:
a. density data;
b. gamma ray data;
c. sonic compressional data;
d. fast sonic shear data;
e. slow sonic shear data; and
f. core data.

5. Method of detection of hydrocarbon horizontal slippage passages according to claim 1, wherein the step of slippage data acquisition and identification comprises one or more of the following steps:
a. core analysis;
b. bore hole image analysis;
c. drilling data analysis;
d. dynamic data analysis;
e. seismic attribute analysis; and
f. curvature/strain analysis.

6. Method of detection of hydrocarbon horizontal slippage passages according to claim 1, wherein the step of slippage passage prediction comprises one or more of the following steps:
a. petrophysical review;
b. determining of slippage passage potential index (SPPI);
c. azimuth, edge, coherency determination and tracking; and
d. curvature/strain analysis.

7. Method of detection of hydrocarbon horizontal slippage passages according to claim 1 wherein the wherein the step of slippage passage prediction comprises the step of creating a 1-dimensional geomechanics model.

8. Method of detection of hydrocarbon horizontal slippage passages according to claim 1; wherein the step of slippage passage characterization comprises one or more of the following steps:
a. creating slippage passage density log and/or slippage passage spacing log for a plurality of wells;
b. slippage passage aperture analysis;
c. estimation of slippage passage density in-between the wells; and
d. geomechanics stress analysis and/or evaluation.

9. Method of detection of hydrocarbon horizontal slippage passages according to claim 1, wherein the step of slippage passage calibration comprises one or more of the following steps:
a. PLT, production data build-up time & RFT/MDT review;
b. well test review.

10. Method of detection of hydrocarbon horizontal slippage passages according to claim 1, further comprising the step of slippage passage upscaling and 3-dimensional slippage passage intensity modeling.

11. Method of detection of hydrocarbon horizontal slippage passages according to claim 1, further comprising the step of generating a slippage passage field wide stochastic slippage passage network.

12. Method of detection of hydrocarbon horizontal slippage passages according to claim 1, wherein the step of slippage passage parameterization and modelling comprises one or more of the following steps:
a. creating a slippage passage porosity distribution model;
b. creating a slippage passage permeability distribution model; and
c. creating an effective slippage passage permeability distribution model.

13. Method of detection of hydrocarbon horizontal slippage passages according to claim 1, wherein the wherein the step of slippage passage parameterization and modelling comprises the step of creating a 3-dimensional MEM and strain map.

14. Use of the method of detection of hydrocarbon horizontal slippage passages according to claim 1 for positioning a well bore for hydrocarbon production.
